(19) United States
(12) Patent Application Publication
(10) Pub. No.: US 2020/0134750 A1
(43) Pub. Date: Apr. 30, 2020

(54) FIELD CONFIGURATION OF AN INSTANCE OF A CLIENT APPLICATION BASED ON A TRANSACTIONAL ROLE OF A USER OF THAT CLIENT APPLICATION TO PREVENT UNINTENDED DISCLOSURE OF CONFIDENTIAL INFORMATION WHEN CLOSING A REAL ESTATE TRANSACTION

(71) Applicant: JetClosing Inc., Seattle, WA (US)

(72) Inventors: David Wolf, Redwwod, WA (US); Arthur C. Delight, IV, Seattle, WA (US); Daniel D. Greenshields, Seattle, WA (US)

(21) Appl. No.: 16/669,400

(22) Filed: Oct. 30, 2019

Related U.S. Application Data
(60) Provisional application No. 62/753,861, filed on Oct. 31, 2018.

(51) Int. Cl. G06Q 50/16; H04L 29/06; G06F 3/0484; G06F 3/0482

(52) U.S. Cl. CPC G06Q 50/16; H04L 63/105; H04L 67/42; G06F 3/04847; G06F 3/0482; H04L 63/0414

(57) ABSTRACT

A system includes a host service configured to distribute a configuration file to one or more instances of a client application configured to communicably couple to the host service. The configuration file informs the behavior of each instance of each client application and the host service so that the system can facilitate secure and private information exchange between parties to a transaction.

### CROSS REFERENCE TO RELATED APPLICATION(S)

This application is a nonprovisional patent application of and claims the benefit under 35 U.S.C. 119(e) of U.S. Provisional Patent Application No. 62/753,861, filed Oct. 31, 2018 and titled “Configuration of an Instance of a Client Application to Facilitate Secure Transaction of Information,” the disclosure of which is hereby incorporated herein by reference in its entirety.

### FIELD

Embodiments described herein relate to network architectures for securely transacting information across computer networks, and, in particular, to systems and methods for field configuration of one or more instances of a client application to collect, distribute, and review confidential and/or private information.

### BACKGROUND

Parties to a legal transaction may exchange documents, data, or information (herein, collectively, “information”) prior to closing escrow to ensure that all agreed-upon conditions to the transaction have been met by all parties. Conventionally, a third party referred to as an “escrow agent” is engaged by parties to an escrow transaction to receive, review, and/or distribute information between the parties.

In many cases, however, conventional methods of collecting, validating, organizing, and/or distributing information between parties and/or party agents are often time-consuming and expensive because rules and requirements for disclosure of information between parties varies, substantially, by legal jurisdiction. As such, escrow agents—and, in particular, systems and software used by escrow agents—typically only facilitate transactions within a specific legal jurisdiction because regularly reconfiguring software and other conventional systems to support the varying rules and requirements of multiple legal jurisdictions—each of which may change from time to time—is prohibitively expensive and complex and, if not performed correctly and accurately, can result in unintended disclosure of private and/or confidential information, potentially exposing an escrow agent to liability.

### SUMMARY

Embodiments described herein reference a system, implemented with a request-response architecture and/or an event-based architecture, including a host service, which may be cloud-based, and multiple instances of a client application communicably coupled to the host service. The multiple instances of the client application are configured to securely exchange information (e.g., manually-entered data, document uploads, and so on) with the host service.

The information, typically, relates to a legal transaction in a particular jurisdiction. The host service is configured to construct and transmit a configuration file to each of the multiple instances of the client application to field-configure each instance of the client application based, at least in part, on (1) a user operating the client application and (2) the particular jurisdiction.

### BRIEF DESCRIPTION OF THE DRAWINGS

Reference will now be made to representative embodiments illustrated in the accompanying figures. It should be understood that the following descriptions are not intended to limit this disclosure to one preferred embodiment. To the contrary, the disclosure provided herein is intended to cover alternatives, modifications, and equivalents as may be included within the spirit and scope of the described embodiments, and as defined by the appended claims.

FIG. 1A depicts a simplified diagram of a system, such as described herein.

FIG. 1B depicts a simplified signal flow diagram of a system including a host service and a client application, such as described herein.

FIG. 1C depicts another simplified signal flow diagram of a system including a host service and a client application, such as described herein.

FIG. 1D depicts another simplified signal flow diagram of a system including a host service and a client application, such as described herein.

FIG. 1E depicts another simplified signal flow diagram of an event-driven system including a host service and a client application, such as described herein.

FIG. 2 depicts another simplified diagram of a system, such as described herein.

FIG. 3 is a flow chart depicting example operations of a method of using a configuration file to inform the behavior and/or operation of an instance of a client application in communication with a host service, such as described herein.

FIG. 4 is a flow chart depicting example operations of a method of creating a configuration file, such as described herein.

FIG. 5 is a flow chart depicting example operations of a method of updating a user interface based on a configuration file, such as described herein.

The use of the same or similar reference numerals in different figures indicates similar, related, or identical items.

Further, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein reference systems and methods for facilitating a close of a legal transaction between two or more parties in a specific jurisdiction enforcing specific rules, regulations, and/or requirements. For simplicity of description, the embodiments that follow reference an “escrow transaction” as one example of a legal transaction; it may be appreciated that this is merely one example.

In particular, described herein are systems and methods for quickly and securely configuring client applications operating on end-user electronic devices (e.g., laptop computers, desktop computers, tablet computers, cellular phones, and so on) for efficient and secure aggregation, validation, formatting, and exchange of structured, unstructured, and/or manually-input data as required by a specified legal jurisdiction (that may enforce specific rules or regulations, that may require the parties to produce particular documents in a particular order, that may require the parties to generate reports based on particular data, and so on) to close a particular escrow transaction.

More specifically, embodiments described herein reference a client-server network architecture that can be dynamically configured for any given escrow transaction in any given legal jurisdiction to collect from, and present to, parties to that transaction, and their representatives, only that information required by that particular jurisdiction to close that particular escrow transaction. The dynamic configuration of the client-server network architecture described herein is based, at least in part, on (1) each user of each instance of a client application and (2) on the specified legal jurisdiction in which the escrow transaction takes place.

As a result of this construction, a single software application can be distributed to all parties to an escrow transaction, including representatives and third parties (e.g., lenders). The software application, once configured such as described herein, displays to the user of the software application only that data and information relevant to that particular party for that particular escrow transaction within that particular jurisdiction. Similarly, the software application, once configured such as described herein, requests from the user of the software application only that data and information required to be produced by that particular party for that particular escrow transaction within that particular jurisdiction.

For example, a buyer and a seller of real property can each operate a separate instance of the same software application but, as a result of the different roles of the buyer and seller, each instance of the software application presents different information and/or a different interface to the buyer and to the seller. In this manner, confidential information of the buyer is not disclosed to the seller, and confidential information of the seller is not disclosed to the buyer. Similarly, the seller is not asked to produce or locate documents required to be produced by the buyer, nor is the buyer asked to produce or locate documents required to be produced by the seller. In this example, neither the buyer nor the seller are required to manually filter information or documents, or to determine whether to produce or withhold a particular document or item of information to advance the transaction to close, or to determine whether the buyer and seller are appropriately disclosing information to the same service or third party in order to close the escrow transaction.

As a result of the constructions, data structures, and configurations described herein, a private real estate transaction—as one example of an escrow transaction—can be closed in a more cost-efficient, time-efficient, private, convenient, and secure manner.

As noted above, it may be appreciated that a private real estate transaction is merely one example and that the various techniques, examples, methods, network architectures, data structures, and systems described herein can be equivalently applied to facilitate other transactions or transaction types including, but not limited to: commercial real estate transactions; insurance purchase transactions (e.g., automotive, health, liability, travel, corporate, business, gap, life, co-insurance, and so on); personal property purchase transactions; asset purchase agreements; and so on. For simplicity of description, however, the embodiments described herein reference escrow transactions and requirements related to a private real estate transaction.

Generally and broadly, embodiments described herein reference a network architecture including a host service. The host service can be implemented in any suitable manner as one or more client-server architecture applications supported by one or more physical servers, network appliances, and/or storage appliances (each of which may include, without limitation: a processor; memory; storage; network connections; and so on) or, additionally or alternatively, supported by a virtual server or container virtualized or containerized in whole or in part in a virtual computing environment. In some cases, the host service can be implemented, in whole or in part, as a cloud service operating on a number of physical servers that may or may not be geographically distributed.

The host service (including any modules, components, plugins, and so on thereof) can be configured to communicably couple to one or more instances of a client application executed, at least in part, by one or more client devices. Each instance of a client application, such as described herein, may be associated with, or otherwise accessible to, one or more parties to a private real estate transaction (e.g., buyer, seller, agents, broker, attorney, lender, inspector, appraiser, insurance provider, and so on). A client device, such as described herein—that may be configured to operate (or execute) an instance of the client application—can be any suitable portable or stationary electronic device including, without limitation: a personal computer (e.g., desktop, laptop, and so on) or a mobile wireless terminal (e.g., a cell phone, tablet, and so on).

The host service and multiple instances of the client application are configured to securely exchange information related to an escrow transaction in order to facilitate a close of that transaction. More specifically, different instances of the same client application are field-configurable depending upon, at least in part, (1) a user, party, or individual having a specified transactional role (and/or more than one transactional role), and (2) the jurisdiction in which the escrow transaction takes place.

In another, non-limiting, phrasing, a single client application can be instantiated on any number of suitable client devices and may be operationally configured in the field when instantiated or at any other suitable time according to a specified parameter set, configuration schema, configuration file, or other suitable operation-defining data or data set (herein, collectively, a “configuration file”) received from the host service in order to appropriately and securely collect, aggregate, validate, format, and/or exchange structured, unstructured, and/or manually-input data between the multiple parties (and/or third parties) to a specified transaction. In many examples, both the client application and the host service can utilize the same configuration file to inform, adjust, schedule, or perform one or more processes, operations, or tasks based on that configuration file.

As one simplified example, a first instance of the client application associated with a particular escrow transaction may be operationally configured according to the transaction role of “buyer” based on a configuration file sent from the host service to that instance of the client application. The first instance of the client application may be further operationally configured according to the jurisdiction, geographic region, or geographic subregion (e.g., country, state, municipality, county, postal code, and so on) in which the particular escrow transaction takes place based on the same configuration file. In this example, the host service can also access or otherwise use the configuration file to change its own operational configuration according to the jurisdiction, geographic region, or geographic subregion in which the particular escrow transaction takes place.

Similarly, a second instance of the client application may be operationally configured according to the transaction role of “seller” based on the same configuration file sent from the host service to both instances of the client application. As with the first instance of the client application and the host service itself, the second instance of the client application can be further operationally configured according to the jurisdiction, geographic region, or geographic subregion in which the particular escrow transaction takes place based on the same configuration file sent to both instances of the client application associated with the particular transaction. In other cases, the seller's instance of the client application can receive a different configuration file sent from the host service. For example, the seller's configuration file may include configuration information for the seller's instance of the client application that is not relevant to the buyer's instance of the client application. In these embodiments, different instances of a client application can receive one or more customized or semi-customized (e.g., customized based on a transaction role or roles associated with a particular instance of the client application) configuration files.

In still further examples, a third instance of the client application may be operationally configured according to both the transaction role of “buyer's agent” and the specific jurisdiction, geographic region, or geographic subregion based on the same configuration file sent from the host service to all instances of the client application associated with the particular transaction.

In still further examples, a fourth instance of the client application may be operationally configured according to the transaction roles of “seller's agent” and “real estate broker” and according to the jurisdiction, geographic region, or geographic subregion in which the particular escrow transaction takes place based on the same configuration file sent to all instances of the client application associated with the particular transaction.

As such, generally and broadly, it may be appreciated that as a result of these described and other equivalent constructions and architectures, a single client application can be distributed to all parties to an escrow transaction. Each of the instances of the single client application can receive the same or different configuration files that may be based, at least in part, on a transaction role associated with a particular instance of the client application. For simplicity of description, however, the embodiments the follow reference an example construction in which a single configuration file is sent to all instances of the client application associated with a particular escrow transaction; it may be appreciated, however, that this is merely one example, and that in other constructions, without limitation: different instances of the client application can receive different and/or customized configuration files; different instances of the client application can receive differently-formatted or encrypted configuration files; different instances of the client application can receive and/or request the configuration file (or more than one configuration file) directly from other instances of the client application in lieu of or in addition to requesting a configuration file from the host service; different instances of the client application can receive different portions, segments, or sections of a single configuration file; different instances of the client application can receive the configuration file at different times and/or in response to different triggers or conditions; and so on.

In this manner, neither the client application nor the host service is required to be engineered, designed, implemented, or structured for the specific benefit of any particular role, party, or individual associated with the escrow transaction, nor is the client application required to be engineered, designed, implemented, or structured according to the rules, practices, or regulations of a particular jurisdiction in which the escrow transaction takes place. Example advantages of such a construction or architecture include, but may not be limited to: reduced software development and maintenance burden for both the client application and the host service; increased confidence that all parties to a transaction are providing information (which may be confidential or private) to the correct party, service(s), or parties; reduced human error (e.g., unintentional information disclosure, information over-disclosure, document loss, misplacement or misfiling, and so on); decreased client application memory footprint and/or complexity; decreased client application processing requirements and/or complexity; increased number of client devices and systems on which a client application can be executed; if a particular jurisdiction changes one or more rules, procedures, or regulations, the client application may not be required to be updated; reduced time to close; and so on.

In one example embodiment, a seller and a buyer of real property—optionally together with any relevant third party, such as a lender, appraiser, or inspector—can each operate a separate client device, each of which executes a unique instance of the client application.

As with other embodiments described herein, each instance of the client application is communicably coupled, typically via an encrypted or otherwise secure communication channel, to the host service (via any suitable wireless and/or wired network, protocol, or technique) to receive from, supply to, or exchange with the host service, information that may be necessary to close the escrow transaction. Each instance of the client application receives a configuration file from the host server based, at least in part, on the geographic location of the real property that is the subject of the escrow transaction. In many embodiments, each instance of the client application receives the same configuration file although this may not be required and, in some embodiments, different configuration files can be sent from the host service to each instance of the client application.

For example, the buyer's instance of the client application can receive a configuration file from the host service and, in response, can generate a suitable single-page or multi-page graphical user interface. The configuration file can be any suitable computer file or stream of data that conforms to any suitable format. In one example, the configuration file is a plain-text file conforming to a Javascript object notation format hosted by the host service and accessed by the buyer's instance of the client application via an appropriate hypertext transfer protocol method (e.g., GET, POST, and so on). It may be appreciated that this is merely one example and that other forms, formats, and file or stream distribution methods or techniques may be used in other embodiments.

In this example, the graphical user interface generated by the buyer's instance of the client application can include one or more buyer-specific data input or data entry fields (e.g., text entry fields, number entry fields, document upload fields, and so on) in order to request specific information from the buyer related to the escrow transaction and to the buyer's role in that transaction. Examples include, but are not limited to: a data field or input element requesting the buyer's name; a data field or input element requesting the buyer's financing information (e.g., pre-approval letter, lender name, lender address, lender contact information, and so on); a data field or input element requesting the buyer upload an identity document (e.g., passport, driver's license, and so on); a data field or input element requesting the buyer upload proof of insurance or insurability; and so on.

The graphical user interface generated by the buyer's instance of the client application of this example can also include one or more data fields or documents for the buyer's review or convenient reference. Examples include, but may not be limited to: the seller's name; the legal or mailing address of the real property that is the subject of the escrow transaction; the seller's agent contact information; and so on.

Additionally, the graphical user interface generated by the buyer's instance of the client application of this example can redact, hide, or otherwise not present or access information or documents related to the escrow transaction that the buyer is not permitted to view. Examples include, but may not be limited to: the seller's contact information; the seller's financing information; the seller's identity documents (e.g., Social Security card, passport, driver's license, and so on); correspondence between the seller and the seller's agent; and so on.

In this manner, the graphical user interface rendered by the buyer's client device of this example is defined, at least in part, by the configuration file received from the host service by the buyer's instance of the client application. As a result, from the buyer's perspective, the client application only requests information from the buyer related to the escrow transaction that the buyer can provide and, additionally, only displays information to the buyer related to the escrow transaction that the buyer is authorized, or otherwise permitted, to view.

Similarly, the seller's instance of the client application of this example can receive the same configuration file (or, in other embodiments, a different seller-specific configuration file) from the host service and, in response, can generate a suitable single-page or multi-page graphical user interface.

In this example, the graphical user interface generated by the seller's instance of the client application can include one or more seller-specific data input or entry fields (e.g., text entry fields, number entry fields, document upload fields, and so on) to request specific information from the seller related to the escrow transaction. Examples include, but are not limited to: a data field or input element requesting the seller's name; a data field or input element requesting the seller upload a property disclosure (e.g., parcel size, structure size, condition, and so on); a data field or input element requesting the seller upload an identity document (e.g., passport, driver's license, and so on); and so on.

Similar to examples described above, the graphical user interface generated by the seller's instance of the client application of this example can also include one or more data fields or documents for the seller's review or convenient reference. Examples include, but may not be limited to: the buyer's name; the buyer's offer; the legal or mailing address of the real property that is the subject of the escrow transaction; the buyer's agent contact information; and so on.

Additionally, as with other examples presented herein, the graphical user interface generated by the seller's instance of the client application can redact, hide, or otherwise not present or access information related to the escrow transaction that the seller is not permitted to view. Examples include, but may not be limited to: the buyer's contact information; the buyer's financing or financial information; the buyer's identity documents (e.g., Social Security card, passport, driver's license, and so on); correspondence between the buyer and the buyer's agent; correspondence between the buyer and the buyer's lender or potential lender; and so on.

In this manner, as with other examples presented herein, the graphical user interface rendered by the seller's client device of this example is defined, at least in part, by the configuration file received from the host service by the seller's instance of the client application. As a result, from the seller's perspective, the client application only requests information from the seller related to the escrow transaction that the seller can provide and, additionally, only displays information to the seller related to the escrow transaction that the seller is authorized or otherwise permitted to view.

Similarly, in many examples, the host service can operate based, at least in part, on the configuration file distributed to and/or requested by one or more instances of the client application. For example, as noted above, a seller's instance of the client application and a buyer's instance of the client application can communicably couple to the same host service in order to advance a particular escrow transaction. In this example, the host service itself can also utilize the configuration file to, without limitation: define one or more databases or table structures based on the escrow transaction, the parties to the escrow transaction, and/or the jurisdiction in which the transaction takes place; define one or more data types or item validation operations or schemas based on the escrow transaction, the parties to the escrow transaction, and/or the jurisdiction in which the transaction takes place; communicably couple to one or more suitable third party databases (e.g., address verification databases, party identification databases, social media databases, municipal or state government databases, federal government databases, and so on); and so on.

It may be appreciated that the preceding examples are not exhaustive and that, generally and broadly, a host service, such as described herein, functions to collect, aggregate, and/or distribute data, documentation, or information (herein, simply, “information”) received from, and/or requested of, one or more specifically-configured instances of a single client application to facilitate a close of an escrow transaction.

Example information that can be exchanged between an instance of client application—operated by any suitable entity or individual associated with, or performing, any suitable role in a given or selected escrow transaction—and a host service, such as described herein, can include, but may not be limited to: a legal and/or mailing address of real property; buyer name; seller name; buyer agent name and/or contact information; seller agent name and/or contact information; parcel description; property description; property tax information; earnest money deposit information; escrow account information; appraisal documentation; inspection documentation (e.g., home, pest, structural, environmental, government mandated, and so on); inspection report information; inspection objection information; insurability information; insurance information; contingency information; pre-approval or financing commitment letters or information; verification of payment or proof of funds information; common interest community documents; homeowners association documents or information; party wall agreements or information; public or private easement information; report information; loan or financing information; lender information; borrower information; seller disclosure information; executed approvals or disclosures; title insurance information; title commitment information; private mortgage insurance information; waiver information; and so on, or any combination thereof.

In addition, as noted above, the type, form, format, and/or detail level of information required to be exchanged between parties to an escrow transaction (and/or third parties), may vary from jurisdiction to jurisdiction. For example, a first jurisdiction may require environmental inspections and/or disclosures (e.g., lead paint disclosures, friable asbestos disclosures, flood disclosures, stigmatized property disclosures, and so on) while a second jurisdiction may not. In another example, a first jurisdiction may require water or mineral rights agreements or disclosures while a second jurisdiction may not. In yet other examples, different jurisdictions may identify, or refer to, the same or similar information, documents, or document types with different terminology. For example, a first jurisdiction may refer to a contract to buy or sell real estate as a “sales contract” while a second jurisdiction refers to the same document by a form number. In still other examples, different jurisdictions may require documents or information to be exchanged, presented, or filed in a different order. As such, in view of the non-exhaustive foregoing examples, it may be appreciated that, generally and broadly, the process of closing escrow may vary, substantially, from jurisdiction to jurisdiction.

Accordingly, and as noted above, each configuration file generated, hosted, served, and/or otherwise presented by a host service, such as described herein is also configured to vary based on the jurisdiction in which an escrow transaction takes place to conform to the specific rules, requirements, timeline, events and actions, taxonomy, vocabulary, and/or regulations of that jurisdiction.

For example, a graphical user interface generated by a buyer's instance of the client application in a first jurisdiction may present a data field requesting that the buyer upload “FORM 1,” which refers to a pre-approval letter. The same graphical user interface generated by the same buyer's instance of the same client application in a second jurisdiction, however, may present a data field requesting that the buyer upload a “Written Lender Statement.”

As another example, a graphical user interface generated by a buyer's instance of the client application in a first jurisdiction may present a data field requesting that the buyer upload a pre-approval letter only after an inspection has been ordered. The same graphical user interface generated by the same buyer's instance of the same client application in a second jurisdiction, however, may request that the buyer upload a pre-approval letter prior to ordering an inspection.

Accordingly, to generate and serve a suitable configuration file that can inform the operation of various instances of a client application, a host system, such as described herein, includes a database of “prototype definitions,” also referred to as configuration parameters. Each prototype definition may represent, and/or be related to, an item of information and, optionally, a sequence or order in which such information may be requested, collected, validated, aggregated, and/or presented in the course of closing a given transaction in a particular jurisdiction. As used herein, the phrase “prototype definition” refers, generally and broadly, to any suitable data structure that defines one or more business rules, financial rules, validation rules, display rules, data attributes, characteristics, relationships, information sources, read or write permissions, formats, identities, aliases, sequence orders, and/or other properties of, related to, triggered by, or depending upon, any item of information that may be required to be provided and/or exchanged in order to close a given transaction in a particular jurisdiction.

A prototype definition, such as described herein, can define for a particular item of information (e.g., data, documents, or documents content) given by a particular jurisdiction: whether the item of information is required to be disclosed; whether the item of information should be redacted, concealed, or otherwise expunged if disclosed; whether the item of information is permitted to be displayed to a particular party (e.g., buyer, seller, lender, agent, and so on); whether the item of information is permitted to be displayed at a particular instance of a client application; whether the item of information should be formatted, when displayed, as a string, number, date, or other data type; whether the item of information should be requested before or after another item of information or document; whether the item of information constitutes personally identifying information or private health information; a name, nickname, alias, or form number by which the jurisdiction refers to the item of information; and so on. It is appreciated that the preceding list of examples is not exhaustive.

In this manner, generally and broadly, a prototype definition of a particular item of information can be used by an instance of the client application or the host server, without limitation, to: generate a portion of a local or remote graphical user interface to request or display the item of information; change or update an existing local or remote graphical user interface to request or display the item of information; validate data input to a specific data field in a local or remote graphical user interface; establish an order in which portions of a graphical user interface appear; establish an order in which one or more documents are requested; establish when and how to notify an operator of the instance of the client application that information is available for review or that a new task in the course of closing an escrow transaction has been completed; determine whether to access a third-party database for, as one example, third-party verification of data input to a graphical user interface (e.g., legal address verification, county record information verification, name or identity verification, and so on); and so on.

In many embodiments, the host system can be configured to package all prototype definitions associated with a particular jurisdiction—along with any other suitable or relevant information—into a single “configuration file,” also referred to as a “jurisdictional schema.”

In many examples, a configuration file or jurisdictional schema can be constructed for a particular jurisdiction by merging or combining particular sets of prototype definitions each corresponding to a different jurisdictional granularity level (e.g., country, state/province, county, city, and so on). In other words, a set of prototype definitions corresponding to a county in which an escrow transaction occurs can be combined or merged with—and/or can inherit the properties, rules, and associations of—the set of prototype definitions corresponding to the respective state in which that transaction occurs. In this example, in the case of duplicate data (e.g., within an individual prototype definition or an entire prototype definition) or conflicting definitions between the county prototype definitions and the state prototype definitions, the county prototype definitions supersede or otherwise override the state prototype definitions. In other cases, the state prototype definitions may supersede or otherwise override the county prototype definitions.

Thereafter, the merged or combined set of prototype definitions can be combined and/or merged with—and/or can inherit the properties, rules, and associations of—the set of prototype definitions corresponding to the respective country in which the escrow transaction occurs. In this example, should a conflict arise, the merged prototype definitions supersede the country prototype definitions, although this may not be required of all embodiments.

It may be appreciated that as a result of this configuration and technique, highly-granular jurisdiction-specific configuration files can be generated on demand, when requested by an instance of a client application. Thereafter, the host service can cache and/or otherwise save that configuration file for later convenient access by one or more instances of the client application.

Further, as a result of this configuration and technique, it may be appreciated that prototype definitions common to multiple jurisdictions (e.g., many jurisdictions may identify a contract to buy or sell real estate as a “Contract”) can be included in higher-level jurisdictional granularities.

For example, since many jurisdictions require the buyer to disclose the buyer's name, a prototype definition of buyer's name information can be included in a country-level set of prototype definitions. Some states, however, may require the buyer to disclose the buyer's complete legal name. In these examples, a prototype definition of buyer's name information, expressly requiring a complete legal name, can be included in a state-level set of prototype definitions.

In this manner, when an escrow transaction takes place in a state that requires a complete legal name, the operation of merging the country-level set of prototype definitions with the state-level set of prototype definitions—the contents of which supersede the country-level prototype definitions should any conflict or collision arise—generates a configuration file that is appropriate for any jurisdiction within that state.

As such, more generally and broadly, embodiments described herein reference a client-server system in which data is securely transacted between clients, facilitated by a server or service (which may be a cloud-based service), in a manner based on one or more configuration files specifically tailored to a particular transaction in a particular jurisdiction (or subject to particular rules).

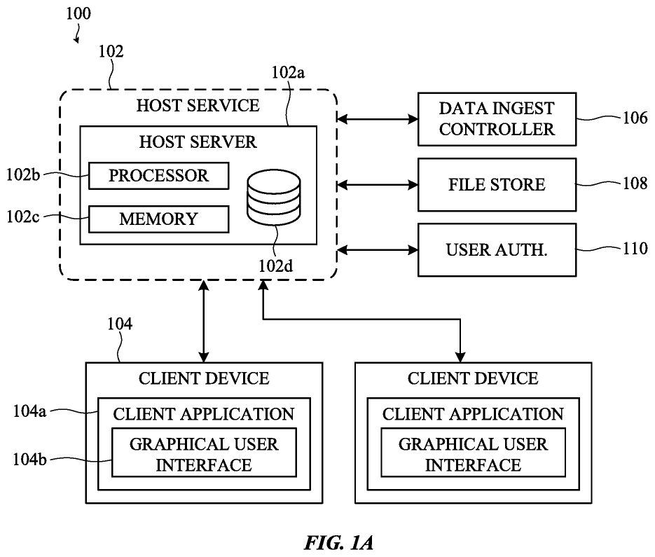

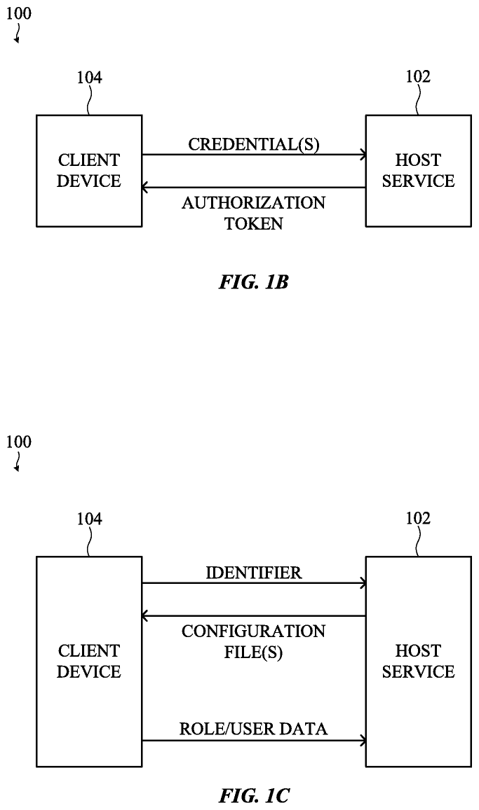

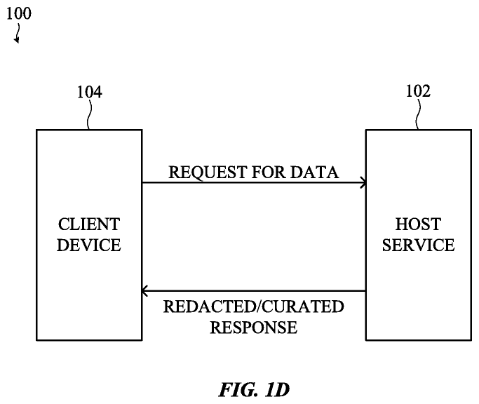

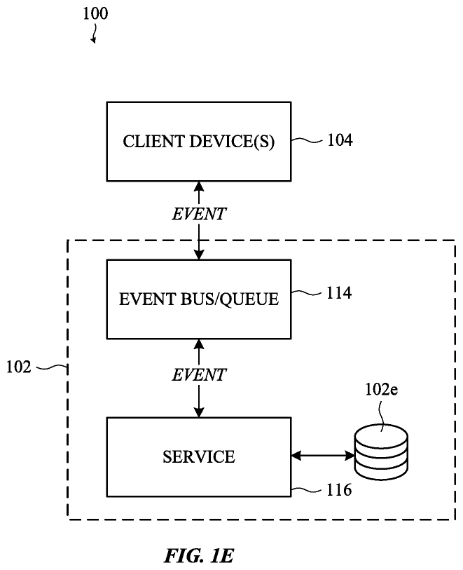

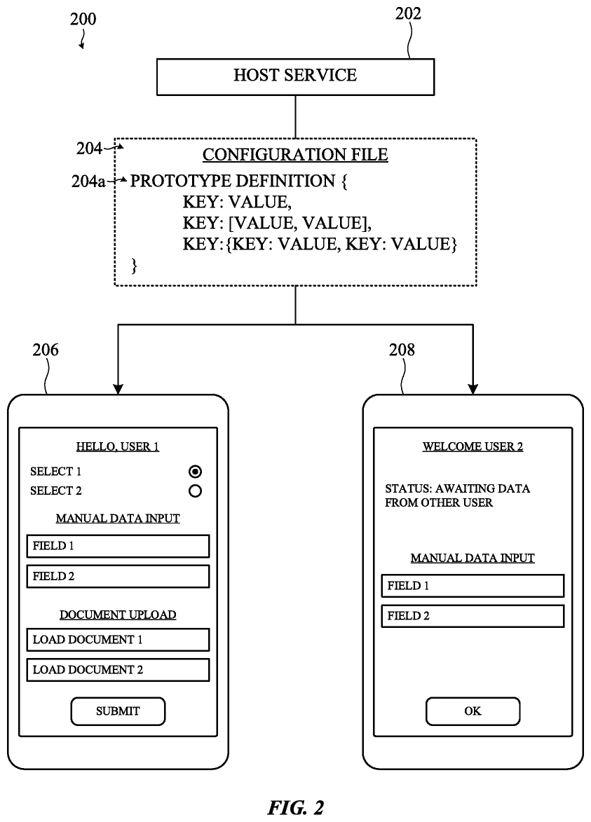

These and other embodiments are discussed below with reference to FIGS. 1A-5. However, those skilled in the art will readily appreciate that the detailed description given herein with respect to these figures is for explanation only and should not be construed as limiting.

For example, FIG. 1A depicts a simplified system diagram of an embodiment described herein. The illustrated system 100 includes a host service 102 communicably coupled to a client device 104 executing an instance of a client application 104a. The instance of the client application 104a accesses one or more services, databases, application programming interfaces, or other resources of the host service 102 via a direct or networked connection.

In many embodiments, the host service 102, which may be a cloud-based service or other distributed networking service, is configured to communicably couple to a number of instances of the client application each executed on different client devices; however, for simplicity of description and illustration, only a single additional client device is depicted (unlabeled).

As noted with respect to other embodiments described herein, the host service 102 can be configured to operate within a virtual or physical computing environment that is supported by one or more servers (labeled as the host server 102a) each including one or more physical hardware resources. Example hardware resources include, but may not be limited to, one or more of: a processor 102b; a memory 102c; a storage array or database 102d; networking connections (not shown); and so on. The host service 102 can be associated with a particular hardware set or particular virtualized instance of a particular hardware set or, in other embodiments, the host service 102 may be implemented with a serverless topology.

The client device 104 can be any suitable device such as, but not limited to: a cellular phone, a laptop computer, a tablet computer, a desktop computer, and so on. Typically, as noted above, the instance of the client application 104a executing on the client device 104 is operated by a party to an escrow transaction, but this may not be required. Example parties include, but may not be limited to: a seller; a buyer; a seller's agent; a buyer's agent; a lender; an inspector; a broker agent; an attorney; an assistant; a paralegal; and so on. For simplicity of description, the embodiments that follow reference a “user” of the instance of the client application 104a executing on the client device 104, which is understood to refer to any individual associated with a particular escrow transaction that physically operates (e.g., interacts with, inputs information to, and so on) an input component (e.g., keyboard, mouse, touch screen, and so on) of the client device 104.

The host service 102 also includes, or is otherwise communicably coupled to a data ingest controller 106, a file store 108, and a user authentication controller 110 that can securely communicate with one another and/or other systems or controllers not shown to collect and exchange information necessary to close an escrow transaction, such as described herein.

In one embodiment, the process of collecting, validating, and distributing information associated with an escrow transaction can begin after the client device 104 and/or the instance of the client application 104a sends an initial signal or communication—via an appropriate communication channel established with the host service 102—to the host service 102 identifying the user of the device.

For example, the instance of the client application 104a can be configured to cause the client device 104 to render a graphical user interface 104b to request that the user provide a username and/or password (or other suitable credential) that can be verified by the user authentication controller 110 in order to identify the user of the client device 104 and/or the instance of the client application 104a.

The user authentication controller 110 can verify the identity of the user of the client device 104 and/or the instance of the client application 104a using any suitable technique. Once a user's identity is confirmed by the user authentication controller 110, the user can be referred to as an “authenticated user.”

Once the user of the client device 104 and/or the instance of the client application 104a is elevated to an authenticated user, the instance of the client application 104a can (optionally) send an additional signal or communication—via the same (or a different) communication channel established with the host service 102 used to identify the user—to the host service 102 identifying a particular escrow transaction the authenticated user desires to advance toward close. In other cases, the host service 102 can determine that the authenticated user is associated with only a single escrow transaction; in these examples, additional signaling or communication to the host service 102 to identify a particular escrow transaction may not be required.

In addition, once the user of the client device 104 and/or the instance of the client application 104a is elevated to an authenticated user, the instance of the client application 104a can (optionally) send an additional signal or communication—via the same (or a different) communication channel established with the host service 102 used to identify the user—to the host service 102 identifying a role of the authenticated user with respect to a particular escrow transaction. In other words, the phrases “authenticated user” and “user” as used herein refer to a real person interacting with a client device and/or a client application, whereas the term “role” refers to the responsibilities, expectations, qualifications, relationships (e.g., principal, agent, debtor, creditor) and so on that can be assigned to one or more authenticated users of the illustrated system 100. Example roles include, but are not limited to: borrower; seller; broker; agent; attorney; assistant; lender; banker; inspector; appraiser; and so on.

In some examples, as noted above, an authenticated user can be assigned to multiple roles at the same time. In these embodiments, a “merged role” can be created and assigned to the user that associates the responsibilities, expectations, qualifications, relationships, and permissions of all roles with a single merged role assigned to the authenticated user.

It may be appreciated that an authenticated user may be associated with only one real person, but one real person may assume multiple roles in the same transaction. In other cases, the host service 102 can determine that the authenticated user is associated with only a single role; in these examples, additional signaling or communication to the host service 102 to identify one or more roles may not be required.

As noted above, for embodiments described herein, the host service 102 is configured to transmit, send, or otherwise convey to the instance of the client application 104a a configuration file including a jurisdiction-specific set of prototype definitions that the instance of the client application 104a can use to, without limitation: generate the graphical user interface 104b; collect necessary information from the authenticated user; determine an order of information to collect from the authenticated user; display information to the authenticated user; validate information received from the authenticated user; and so on.

In many embodiments, a configuration file associated with a specific jurisdiction can be precomputed, cached, and stored in the file store 108 for access by the instance of the client application 104a at any time (e.g., via a hypertext transfer protocol request or another application programming interface request). In other cases, a configuration file (or more than one configuration file, each associated with a different authenticated user or transactional role) can be dynamically generated, cached, and stored in the file store 108 when requested on demand by an instance of the client application. As noted above, one example format in which a configuration file can be stored in the file store 108 is a Javascript object notation format (herein “JSON”). It may be appreciated, however, that this is merely one example. Other suitable file types and/or file formats include, but are not limited to: YAML; extensible markup language; generic markdown; hypertext markup language; plaintext; portable document format; and so on. For simplicity of description, the embodiments that follow reference configuration files that may be created, transferred, accessed, and stored in a JSON file format.

In other examples, a configuration file associated with a specific jurisdiction is not precomputed or cached when requested by the instance of the client application 104a. In these examples, the file store 108 and/or other components of the host service 102 can be configured to merge one or more jurisdiction-specific sets of prototype definitions. For example, the file store 108 and/or other components of the host service 102 can be configured to merge the content of a county-level set of prototype definitions stored in a first JSON-formatted file (or data structure held in a memory, such as the memory 102c or the file store 108) with the content of a state-level set of prototype definitions stored in a second JSON-formatted file with the content of a country-level set of prototype definitions stored in a third JSON-formatted file. These examples are not exhaustive and it may be appreciated that other means of combining sets of prototype definitions or updating individual prototype definitions can be used in other embodiments.

As noted above, the data ingest controller 106 is configured to receive and/or collect information in the form of digital data from the instance of the client application 104a in any number of suitable ways, each of which may be guided or informed, at least in part, based on the role(s) of the authorized user and/or content of the configuration file received by the instance of the client application 104a.

For example, as noted above, in many embodiments, the data ingest controller 106 is configured to collect, validate, and organize information related to (or directly provided by) the authorized user via the graphical user interface 104b of the instance of the client application 104a. The information from the authorized user can include any suitable information related to an escrow transaction such as, but not limited to: identity information; tax information; real or personal property information; income information; savings information; debt information; family information; real estate information; employment information; contact information; financing information; inspection objection information; loan information; appraisal information; and so on.

In one example, the authorized user is a buyer of real property in a specified county, state, and country and is assigned the role of “Buyer.” In this example, the instance of the client application 104a can access the file store 108 to obtain a configuration file specific to the county, state, and country in which the real property resides. The configuration file is either created by the file store 108 on demand or, alternatively, is retrieved from a cache within the file store 108. The configuration file, as noted above, is the result of merging a county-level set of prototype definitions with a state-level set of prototype definitions and a country-level set of prototype definitions.

Based on the configuration file received from the file store 108, the instance of the client application 104a can determine what information related to the transaction, if any, should be displayed by the graphical user interface 104b. More specifically the instance of the client application 104a can determine what data is permitted to be viewed by a user assigned to the role of Buyer based on the prototype definition(s) of that data per the configuration file If the instance of the client application 104a determines that a specific item of information should be shown to a user assigned to the role of Buyer, the instance of the client application 104a can query the file store 108 for such information. In response, the file store 108 can optionally verify the identity and/or the role(s) of the authorized user (e.g., by communicating with the user authentication controller 110) prior to accessing a database to return the requested information to the instance of the client application 104a. Once the information is received, the instance of the client application 104a can update the graphical user interface 104b to display the information to the authorized user.

Additionally, based on the configuration file received from the file store 108, the instance of the client application 104a can determine what information is required to be supplied by the buyer. More specifically, the instance of the client application 104a can determine what information, if any, is required to be supplied by a user assigned the role of Buyer. If the instance of the client application 104a determines that no information is required from a user assigned to the role of Buyer, then no information is requested from the authorized user. Alternatively, if the instance of the client application 104a determines that information is required from a user assigned to the role of Buyer, then the graphical user interface 104b can be updated by the client application 104a to request that information.

Once collected as digital data, the instance of the client application 104a can validate the data by performing a suitable data validation operation that may, in some cases, be based at least in part on a prototype definition corresponding to the intended or expected content of the collected digital data. In some examples, a data validation operation may include, but may not be limited to: spelling validation; grammar validation; format validation; numerical range validation; forbidden character checking; data sanitizing operations; and so on. Generally and broadly, data that has been validated and/or sanitized by the instance of the client application 104a is referred to herein as “validated data.”

Thereafter, the instance of the client application 104a can communicate the validated data to the data ingest controller 106, either directly or indirectly via another server, service, or component of the host service 102. Validated data can be received by the data ingest controller 106 in a variety of suitable forms or formats including, but not limited to: manually input data; retrieved data (e.g., structured data from a first-party or third-party database in response to a query, such as address data); extracted data (e.g., values extracted from documents, such as tax data extracted from tax documents); inferred data (e.g., values determined based on existence or absence of data, such as employment status based on tax information); and/or calculated data (e.g., calculated data based on other data, such as an age from birthdate information); and so on. Thereafter, the data ingest controller 106 can communicate the received validated data to the file store 108 for secure and encrypted storage and retrieval at a later time or by another party to the escrow transaction.

As a result of the topology described herein, it may be appreciated that the host service 102 need not necessarily receive, disclose, or store any unnecessary information or any improperly-formatted information supplied by an authorized user. As a result, in many embodiments, no party to the escrow transaction should receive any unnecessary information, any partially-complete information, or any improperly-formatted information from another authorized user.

In further examples, the data ingest controller 106 and/or the instance of the client application 104a may be configured to determine an efficient means of collecting information required for a particular escrow transaction based, at least in part, on the configuration file associated with that transaction. For example, the data ingest controller 106 may be associated with or may be in communication with a document content database (not shown) that stores information about data typically contained in various documents, such as driver's licenses, bank statements, tax forms, real estate documents, passport documents, social media sites, email databases, and so on. The data ingest controller 106 may query the document content database with information from the configuration file received from the file store 108 and the database may return an optimized or minimized set of document types that contain all or substantially all information required to complete one portion of the escrow transaction. In this manner, unnecessary data entry by the authorized user is mitigated.

One may appreciate that as a result of limiting the information collected and disclosed by the host service 102, unnecessary disclosure of information is reduced, and privacy and confidentiality is protected.

Further, it may be appreciated that specific implementations of the data ingest controller 106 and the file store 108 can vary from embodiment to embodiment. In many cases, the data ingest controller 106 and the file store 108 are implemented as (or on, as a set of computer instructions stored in a non-volatile memory) virtual and/or physical servers or server clusters that communicate with one another across one or more secure communication channels. In other cases, one or more portions of the data ingest controller 106 or the file store 108 may be implemented in software distributable to an electronic device of the authorized user, such as the client device 104.

The foregoing embodiments depicted in FIG. 1A and the various alternatives thereof and variations thereto are presented, generally, for purposes of explanation, and to facilitate an understanding of various configurations of a system, such as described herein. However, it will be apparent to one skilled in the art that some of the specific details presented herein may not be required in order to practice a particular described embodiment, or an equivalent thereof.

For example, it may be understood that—generally and broadly—embodiments described herein reference a system for facilitating exchange of documents and information between parties to an escrow transaction. The system includes a host service configured to distribute a jurisdiction-specific configuration file to a number of instances of a client application, each operated by a different authorized user (that may be assigned one or more roles). Each instance of the client application receives the jurisdiction-specific configuration file and performs one or more operations to advance the escrow transaction based on the content of the jurisdiction-specific configuration file.

For example, an instance of the client application may display and/or request only certain information defined in the jurisdiction-specific configuration file to and from an authorized user assigned the role of “buyer.” Similarly, an instance of the client application may display and/or request only certain information defined in the jurisdiction-specific configuration file to and from an authorized user assigned the role of “seller.” In still further examples, the client application and/or the host service can produce one or more reports or data outputs formatted or organized based on information defined in the jurisdiction-specific configuration file.

In still further examples, an instance of the client application may communicate at arbitrary or specific times, across any suitable protocol or communication channel or combination of protocols or communication channels, directly or indirectly with the host service (which may be implemented as a cloud-based client-server application), or a component, module, or subsystem thereof (e.g., data ingest controller(s), file store(s), user authentication service(s), and so on).

For example, continuing an example introduced above, FIG. 1B depicts a simplified communication diagram illustrating one example exchange of information that may occur between an instance of a client application and a host service, such as described herein. In particular, the illustrated system 100—which may be the same system as described in reference to FIG. 1A—can include a host service 102 and a client device 104. Both the host service 102 and the client application 104 can be configured in the same manner as described above in reference to FIG. 1A; this description is not repeated. In this embodiment and example, a user of a client device 104 can instantiate an instance of a client application configured to communicate with the host service 102 using any suitable technique. In one example, the user launches a software application resident on the client device 104 (e.g., computer code or instructions associated therewith stored locally in a non-transitory memory within the client device 104). In another example, the user launches a browser application residence on the client device 104 and initiates a request for a particular uniform resource locator that, in turn, causes a remote server to transmit rendering instructions to the browser application to generate a user interface corresponding to the client application. In still further examples, the user can operate the client device 104 to submit a request to a local or remote server to download an instance of or executable copy of the client application. It may be appreciated that the foregoing examples are not exhaustive and that in other embodiments, the user may instantiate the client application or may otherwise cause the client application to be instantiated in another suitable way.

Once the user has instantiated the client application on the client device 104, the user may be presented with a login screen requesting that the user identify him or herself to the instance of the client application operating on the client device 104 and, by extension, to the host service 102 that is configured to communicate with the client device 104. In one example, the user may provide a username and password to the login screen. This is merely one example—in other cases, additional or alternative information can be provided by the user to identify the user to the illustrated system 100 including, but not limited to: biometric information; third-party login information; a camera image; a sound; a Turing test; and so on.

In response to receiving identifying information from the user, the instance of the client application executed by the client device 104 can communicate—via one or more communication channels provided by or in, or otherwise communicably accessible to the client device 104 (e.g., Bluetooth, ethernet, Wi-Fi, and so on)—that information with the host service 102. In many cases, the information communicated from the client device 104 to the host service 102 is encrypted or otherwise encoded for security. In response to receiving the information from the client device 104 (in this example, referred to as “credentials” for simplicity of description), the host service 102 can access a user database or user authentication service or server (such as the user authentication controller 110 depicted in FIG. 1A). If the credentials supplied by the user do not match or are otherwise not associated with any previously-authenticated user, the host service 102 can send a signal or communication back to the client device 104 indicating the same, denying the user of the client device 104 access to the illustrated system 100. Alternatively, if the credentials supplied by the user do match or are otherwise associated with a previously-authenticated user, the host service 102 can send a signal or communication back to the client device 104—via the same or a different communication channel used by the client device 104 to communicate the credentials to the host service 102—granting access to the illustrated system 100.

In one example, the information sent by the host service 102 to the client device 104 in response to determining that the credentials supplied by the client device 104 match a previously-authenticated user can take the form of a session token or other cryptographically-verifiable data item that can be used by the client device 104 to readily and quickly access the host service 102 at a later time without requiring the user to supply credentials again. In some cases, the session token may be configured to expire after a predefined or variable period of time. In some cases, the host service 102 can be configured to revoke a session token without permission of or input from a user.

In still other examples and as noted above, a host service and a client application operating on or executed by a client device, such as described herein, can exchange additional information in the course of closing an escrow transaction (or any other suitable transaction that may vary from party to party or jurisdiction to jurisdiction), such as described herein.

For example, FIG. 1C depicts a system such as shown and described in reference to FIGS. 1A-1B including a host service 102 and a client device 104 executing an instance of a client application. The various configurations and operations of the host service 102 and the client device 104 of the illustrated system are described in reference to FIGS. 1A-1B and are not repeated.

In this example, an instance of a client application executed by a processor of the client device 104 can be configured to communicate a signal or communication to the host service 102 that includes an identifier. In some cases, the identifier can serve to identify a particular authenticated user (e.g., a session token such as described in reference to FIG. 1B) or a particular role associated with or otherwise associated with an authenticated user. Example identifiers that can be communicated from an instance of a client application to the host service 102—or, more generally, any host service such as described herein—include, but may not be limited to: a session token; a username; a party role (e.g., broker, buyer, agent, seller, attorney, assistant, inspector, and so on); a merged party role (e.g., a broker/agent, a buyer/agent, and so on); an indicator of party sophistication (e.g., professional, legal representative, non-attorney, non-agent, private buyer, private seller); and so on.

In response to receiving the identifier from the instance of the client application executed by the client device 104, the host service 102 can supply a configuration file such as described above. As noted with respect to many embodiments described herein, the configuration file can be customized and/or otherwise specifically configured for the particular user, the particular role or merged role assigned to or associated with a particular user, party sophistication, and so on. The configuration file can be used by the host service 102 and the client device 104 to inform the generation of a graphical user interface on the client device 104 and to guide, order, and select the particular documents or information request of and/or displayed to the user of the client device 104.

For example, given a particular transaction in a particular jurisdiction, a buyer's instance of the client application may request information from and display information to the buyer that is only relevant to the buyer; seller-confidential information is not displayed to the buyer from the buyer's instance of the client application as a result of the configuration file sent from the host service 102. Similarly, a seller's instance of the client application may request information from and display information to the seller that is only relevant to the seller; buyer-confidential information is not displayed to the seller from the seller's instance of the client application as a result of the configuration file sent from the host service 102.

In further embodiments, the seller may be a sophisticated party (e.g., an attorney, a real estate agent). In these examples, the configuration file sent to the client device 104 can cause the client device 104 to display only that information that is relevant to a sophisticated party. For example, colloquial terms that may be presented to an unsophisticated party may be substituted for legal or industry terms. In another example, descriptive language written in simplified language may be substituted for legal terminology suitable for consumption by the sophisticated party.

These foregoing examples are not exhaustive; it may be appreciated that a configuration file generated or served in response to receiving an identifier such as shown in FIG. 1C can be customized to a particular role, a merged role (e.g., a superset of all permissions, documents, and/or data types or validation schemas associated with each role to be merged), a particular user, a particular transaction, a particular jurisdiction, and so on. As a result of the configuration file customized for a particular instance of a client application executed by a particular client device, the user of the client device may be able to submit to the host service 102 only that information which is relevant to that user and/or that user's role(s).

Phrased in another, non-limiting manner, the host service 102 can be configured to redact and/or specifically curate information sent to a client device, such as the client device 104, in response to a request from that client device for information related to a transaction. The amount and type of redaction and/or curation may be based, at least in part, on the configuration file or files relevant to a particular transaction in a particular jurisdiction. For example, as noted with respect to other embodiments described herein, the configuration file may be based, at least in part on (without limitation): the user operating the instance of the client application executed by the client device 104; the jurisdiction in which the transaction takes place; the type of transaction; and so on.

In many cases, the configuration file(s) sent from the host service 102 to the client device 104 can be pre-compiled and hosted as a static file by the host service 102. In these embodiments, the request or identifier sent from the client device 104 can include or more of a user's name, a user's role, a transaction identifier, or a jurisdiction. In response, the host service 102 can create and/or access a previously-created configuration file based on the information sent from the client device 104. In one specific example, the host service 102 can include a configuration file service that exposes an application programming interface to the client device 104 that is accessible via the Internet or another communication channel defined between the client device 104 and the host service 102. For example, the application programming interface of one embodiment can be a RESTful application programming interface or a response-request application programming interface. In this example, the client device 104 can submit a hypertext transfer protocol request to the application programming interface including the identifier. In response, the host service 102 can return one or more appropriate configuration files.

In one specific implementation of the example presented above, a given transaction can take place in King County of Washington state in the United States. A user assigned the role of buyer for the given transaction may be an unsophisticated party whereas a user assigned the roles of seller and agent for the given transaction may be a sophisticated party.

In this example, the buyer's instance of the client application can submit a request to the host service 102 that includes the buyer's role, the jurisdiction, and the buyer's sophistication. More specifically, the buyer's instance of the client application can generate a GET request to the host service 102 conforming to a uniform resource locator format of: https://host-service/united-states/washington/king-county/buyer/unsophisticated. In response to this GET request, the host service 102 can return to the buyer's instance of the client application a configuration file in which the prototype definitions associated with the United States jurisdiction are merged with the prototype definitions associated with the Washington state jurisdiction are merged with the prototype definitions associated with the King County jurisdiction. In addition, the configuration file returned by the host service 102 can be tailored to an unsophisticated buyer; legal terms or industrial terminology can be substituted for colloquial terminology, additional explanation or external references may be included, and so on. The buyer's instance of the client application can use the configuration file to generate a graphical user interface to present information to and request information from the buyer.

Continuing this example from the seller's side, the seller's instance of the client application can submit a request to the host service 102 that includes the seller's roles, the jurisdiction, and the seller's sophistication. More specifically, the seller's instance of the client application can generate a GET request to the host service 102 conforming to a uniform resource locator format of: https://host-service/united-states/washington/king-county/seller-broker/sophisticated. In response to this GET request, the host service 102 can return to the seller's instance of the client application a configuration file in which the prototype definitions associated with the United States jurisdiction are merged with the prototype definitions associated with the Washington state jurisdiction are merged with the prototype definitions associated with the King County jurisdiction. This configuration file can be the same configuration file sent to the buyer's instance of the client application referenced above. Alternatively, the configuration file returned by the host service 102 can be tailored to an sophisticated seller assigned multiple roles. The seller's instance of the client application can use the configuration file to generate a graphical user interface to present information to and request information from the seller. The seller's graphical user interface is different from the buyer's graphical user interface at least in part due to the user's different roles and sophistication.

In other cases, the configuration file(s) sent by the host service 102 to the client device 104 can be dynamically generated and/or demand.

It may be appreciated the preceding specific example of a uniform resource locator application programming interface is merely one example means of accessing or requesting configuration file information from a host service such as described herein. Further, it may be appreciated that in some embodiments, a client application may request information related to a transaction. For example FIG. 1D depicts a system such as the system described in reference to FIGS. 1A-1C. The illustrated system 100 in FIG. 1D can be configured in the same or a similar manner as described in reference to FIGS. 1A-1C; this description is not repeated. In this example, a client device 104 submits a request for information regarding a particular transaction from the host service 102. In response, and based on at least one or more configuration files associated with the particular transaction, the host service 102 returns a redacted and/or otherwise curated response that is appropriate to disclose to the user of the client device 104.

For example, a user of the client device 104 may be assigned the role of seller. If the user—or, more accurately, the instance of the client application executed by the client device 104—submits a request to the host service 102 that could result in disclosure of confidential information of the buyer, the host service 102 may respond to the request by denying the request, by redacting buyer-confidential information, or by responding only with only information that is not buyer-confidential.

For example, a user assigned the role of seller may request to confirm that the buyer has arranged appropriate financing. The host service 102 may be configured, based on one or more configuration file associated with the transaction, to determine that the role of seller does not have appropriate permissions to view or otherwise receive a document that may include the buyer's personally identifying information (e.g., social security number). As such, the host service 102 may return to the seller, in response to the seller's request, a redacted pre-approval letter uploaded to the host service 102 by the buyer's instance of the client application; the buyer's personally identifying information is redacted from the document served to the seller. In other cases, the host service 102 can return to the seller only the name of the financing institution engaged by the buyer.

It may be appreciated that the foregoing examples are not exhaustive; a client application and a host service, such as described herein, can transact any suitable information in any suitable form or format based on one or more configuration files associated with a particular transaction. More generally, in view of the examples described in reference to FIGS. 1A-1D, it may be appreciated that a configuration file, such as described herein, informs the behavior of a client application and, in part, a host service, based at least in part on (1) the identity of the user operating an instance of the client application at a particular time, (2) that user's role(s)—whether those roles are merged or otherwise—and (3) the jurisdiction in which an escrow transaction takes place.

Similarly, it may be appreciated that a system, such as described herein, can be implemented with any number of suitable communications architectures. For example, although many embodiments described herein reference a request-response architecture, it may be appreciated that this is merely one example. More specifically, in other embodiments, such as shown in FIG. 1E, an event-driven architecture can be used. In particular the system 100 depicted in FIG. 1E shows a host service 102 communicably coupled to a client device 104. The host server 103 includes an event bus 114 (also referred to as an event dispatch, an event queue, a message queue, or any other suitable similar phrase). The event bus 114 is configured to asynchronously receive and store discrete data items referred to as “events” formatted according to a specification or protocol unique to the system 100 and/or conforming with a specified messaging protocol. In this example, the event bus 114 can receive events from the client device 104 and store those events in a queue based on a time stamp or indexed order in which each event was received and/or added to the event bus 114. Thereafter, events stored by the event bus 114 can be consumed by one or more services, servers, microservices, functions, lambda functions, and so on associated with an operation or task of the host service 104. Collectively, these example event-consuming elements are depicted in FIG. 1E as the service 116. The service 116 can receive and/or consume events and/or be notified of new events from the event bus 114 in any suitable manner. Examples include, but are not limited to: registering the service 116 as a callback executed by the event bus 114 once an event of a given type is received; registering the service 116 as a subscriber of a particular message type generated by the event bus 114 in response to the event bus 114 receiving an event of a particular type or an event that changes a particular state; registering the event bus 114 as a subscriber of one or more announcements of state changes or events periodically generated or broadcast by the event bus 114; and so on. In some embodiments, the service 114 can include or can be coupled to a state database 102e that locally stores partial or complete state information or event information, at least partially mirroring information contained/stored by the event bus 114.

The foregoing example communication architecture is not exhaustive of the various types of communication(s) that can be implemented to exchange and/or process information through a system, such as described herein. As such, it may be appreciated that, generally and broadly and regardless of architecture or implementation, a system such as described herein is configured to cause one or more client devices executing the same client application to self-configure and display different information based on a configuration file, schema, or other instruction.

For example, FIG. 2 depicts a simplified system diagram of an embodiment such as described herein. In this example, the system 200 includes a host service 202 configured to distribute a configuration file 204 to two separate client devices, identified as the client devices 206, 208. The client devices are each configured to execute an instance of a client application, such as described herein.

As with other embodiments described herein, the configuration file 204 can include one or more prototype definitions, such as the prototype definition 204a. Example prototype definitions, and uses thereof, are provided above and are not repeated here. The prototype definition 204a can include any suitable data in any suitable format.

The instances of the client application executed by the client devices 206, 208 receive the configuration file 204 from the host service 202 and, in response, adjust behavior based on the content of the configuration file 204. For example, the instance of the client application executed by the client device 206 may show different information than the instance of the client application executed by the client device 208 if the client device 206 is operated by a first user having a first role and the client device 208 is operated by a second user having a second, different role. In some cases, either the first role or the second role can be merged roles, but this may not be required.

It may be appreciated that the foregoing embodiment depicted in FIG. 2 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, generally and broadly, it may be appreciated that a prototype definition in a configuration file can be used by a host service and/or an instance of the client application for a number of suitable purposes including, but not limited to: generating a timeline of events and/or a sequence of information required to close a particular escrow transaction; generating a report or other data output conforming to a particular jurisdictional requirement; formatting data or information according to a particular jurisdictional requirement; accessing data from a third party preferred or required by a particular jurisdictional requirement; changing an aspect of a graphical user interface based on a particular jurisdictional requirement (e.g., using jurisdictional taxonomy or vocabulary to identify certain information); changing a timeline of events and/or a sequence of information required to close a particular escrow transaction based on an event received from a third party or third party service; executing one or more business rules in response to a trigger; creating one or more business rules; scheduling executing of one or more software programs or server operations; and so on.

In still further examples, it may be appreciated that a configuration file can be constructed in a number of ways. For example, as noted above, a jurisdiction-specific configuration file can be created by merging and/or combining different sets of prototype definitions that correspond to different jurisdictional granularity levels; a county-level set of prototype definitions is merged with a state-level set of prototype definitions that, in turn, is merged with a country-level set of prototype definitions, and so on.

In other examples, different granularity-level sets of prototype definitions can be merged. For example, in one example, a configuration file may be requested for a county for which a county-level set of prototype definitions has not been generated. In this example, a state-level set of prototype definitions can be combined or merged with a country-level set of prototype definitions. In other words, the next-smallest granularity level can be selected.

More broadly, it may be appreciated that any number of suitable methods or operations can be performed by a system such as described herein or a component thereof, such as a host service or an instance of a client application, such as described herein.

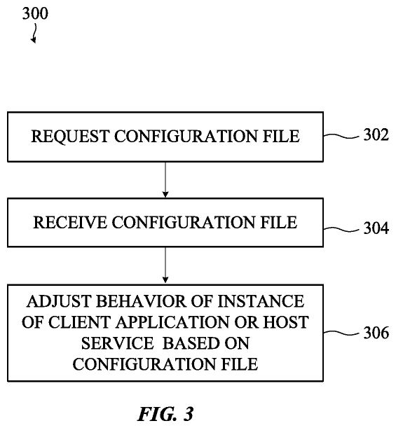

FIG. 3 is a flow chart depicting example operations of a method of using a configuration file to inform the behavior and/or operation of an instance of a client application in communication with a host service (which may be local or remote or otherwise cloud-based), such as described herein.

In particular, the method 300 includes operation 302 in which a configuration file, such as described herein, is requested. The request can be made, in some examples, by an instance of a client application operating on a client device, such as described herein, but this is not required. For example, in other embodiments, the request can be made by a host service such as described herein. As noted with respect to many embodiments described herein, the configuration file can be jurisdiction-specific.

The method 300 also includes operation 304 in which, after the request at operation 302 is made, the requested configuration file is received. In some cases, the configuration file can be formed, structured, created, formatted, packaged, compressed, or otherwise modified on demand in response to the request at operation 302, although this is not required. In other examples, the configuration file can be retrieved and/or accessed from a cache or a database.

The method 300 also includes operation 306 in which the behavior and/or operation of an instance of a client application in communication with a host service or, alternatively or additionally, the host service itself can be changed, augmented, updated, or otherwise defined.

In many cases, as described above, a configuration file can be jurisdiction-specific. As a result, the behavior and/or operation (e.g., graphical user interface, timeline or sequence of events, and so on) of an instance of the client application can be tailored to the specific jurisdiction.

In many cases, as described above, a configuration file can be authorized user or role specific. As a result, the behavior and/or operation (e.g., data shown or hidden, data redacted or presented, and so on) of an instance of the client application can be tailored to a specific user and/or a specific role (or combination of roles).

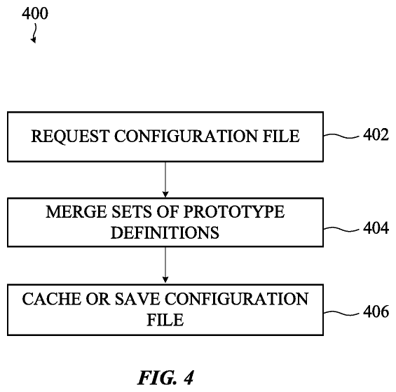

FIG. 4 is a flow chart depicting example operations of a method of creating a configuration file that can be served by, dynamically generated by, streamed by, or otherwise distributed by a cloud-based or other host service, such as described herein. The method 400 includes the operation of requesting a configuration file at operation 402. As with the method described in reference to FIG. 3, the request can be made, in some examples, by an instance of a client application operating on a client device, such as described herein, but this is not required. For example, in other embodiments, the request can be made by a host service such as described herein. As noted with respect to many embodiments described herein, the configuration file can be jurisdiction-specific.

The method 400 also includes operation 404 in which one or more sets of prototype definitions are selected and merged. In many embodiments, each set of prototype definitions is associated with a particular geographic or jurisdictional granularity, such as a country, state, or county. In other cases, other sets of prototype definitions can be merged. The method 400 also includes operation 406 in which the merged set of prototype definitions is saved, cached, or otherwise stored in a database for ready access at a later time.

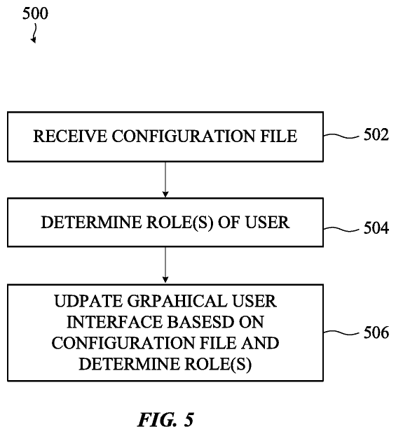

FIG. 5 is a flow chart depicting example operations of a method of updating a user interface based on a configuration file distributed from or served by a service such as a cloud-based host service, such as described herein. The method 500 includes operation 502 in which a configuration file, such as described herein, is received by an instance of a client application, such as described herein. Next, at operation 504, the instance of the client application can determine one or more roles of a user operating the client application. Example roles of a user are non-exhaustively listed above and are not repeated. Finally, at operation 506, the instance of the client application can update its graphical user interface based, at least in part, on the configuration file and, at least in part, on the role(s) determined at operation 504. Example updates that can be performed to a graphical user interface, such as described herein, can include but are not limited to: showing or hiding of particular buttons, text entry fields, descriptions, images, and so on; changing an animation setting; changing a color or theme; changing a vocabulary or taxonomy used to refer to particular data or data entry fields; changing between professional vocabulary and colloquial vocabulary; hiding private information; redacting private information from one or more documents; showing one or more documents; and so on.

The foregoing embodiments depicted in FIGS. 3-5 and the various alternatives thereof and variations thereto are presented, generally, for purposes of explanation, and to facilitate an understanding of various methods for operating a system, such as described herein. However, it will be apparent to one skilled in the art that some of the specific details presented herein may not be required in order to practice a particular described embodiment, or an equivalent thereof.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

We claim:

1. A system for field configuration of an instance of a client application configured prevent unintended disclosure of confidential financial information between parties to a real estate transaction when closing the real estate transaction, the system comprising:
a host server; and
a client device operated by a party to the real estate transaction, the client device communicably coupled to the host server and comprising:
a display;
a memory configured to store executable instructions; and
a processor configured to access the memory and execute the executable instructions to instantiate a local instance of the client application configured to:
render a graphical user interface via the display to receive input from, and to provide output to, the party to the real estate transaction;
determine a role of the party relative to the real estate transaction based on a credential submitted by the party to the client application via the graphical user interface;
request from the host server a configuration file, the request comprising the role and an identifier corresponding to the real estate transaction;
receive from the host server the configuration file; and
modify the graphical user interface based on the configuration file such that the graphical user interface solicits only role-specific input from the party and provides only role-specific output to the party.

2. The system of claim 1, wherein a modification of the graphical user interface comprises one or more of:
showing or hiding one or more of:
an input button;
a text input field;
a document upload field;
a label text;
an image or graphic;
a redaction of a portion of a document; or
a document; or
changing one or more of:
an animation;
a sound; or
a vocabulary or taxonomy used to refer to selected data entry fields.

3. The system of claim 1, wherein the role of the party comprises one or more of:
a real estate agent;
a real estate purchaser;
a real estate buyer; or
a real estate broker.

4. The system of claim 1, wherein the host server is configured to:
in response to the request for the configuration file, select one or more of a set of configuration parameters based on the identifier and the role; and
merge each elected configuration parameter into the configuration file.

5. The system of claim 4, wherein:
the request is a first request;
in response to the first request, the host server is configured to cache the configuration file; and
in response to a second request for the configuration file, the host server is configured to serve the cached configuration file.

6. The system of claim 4, wherein the set of configuration parameters comprises one or more of:
a sequence or order in which information related to the real estate transaction is:
requested from the party based on the role;
validated after being received from the party;
aggregated with other information after being received from the party; or
presented to the party in the graphical user interface;
a business rule;
a financial rule;
a data validation rule;
a graphical user interface display rule;
a data format rule; or
a data validation rule.

7. The system of claim 1, wherein the configuration file is encrypted.

8. The system of claim 7, wherein the encryption of the configuration file is based, at least in part, on one or more of:
the credential;
the party;
the role; or
the real estate transaction.

9. The system of claim 1, wherein:
the client device is a first client device;
the party is a first party;
the role is a first role;
the local instance is a first local instance;
the configuration file is a first configuration file; and
the system further comprises a second client device operated by a representative of a second party to the real estate transaction, the second client device communicably coupled to the host server and configured to instantiate a second local instance of the client application, the second local instance configured to request from the host server a second configuration file, the second configuration file based on a second role of the representative and the identifier.

10. The system of claim 9, wherein:
the graphical user interface is a first graphical user interface; and
the second local instance is configured to modify a second graphical user interface such that the second graphical user interface solicits input from the representative specific only to the second party or to the representative and provides output to the representative specific only to the second party or to the representative.

11. A method of preventing unintended disclosure of confidential information exchanged between parties to a real estate transaction when closing the real estate transaction, each party operating respective one client device each executing a discrete instance of a client application, each discrete instance of the client application communicably coupled to a host service, the method comprising:
requesting, by a first instance of the client application, a first credential from a first party to the real estate transaction;
transmitting to the host service by the first instance data corresponding to the first credential;
requesting, by a second instance of the client application, a second credential from a second party to the real estate transaction;
transmitting to the host service by the second instance data corresponding to the second credential;
assigning, by the host service, a first role in the real estate transaction to the first party based on the first credential;
assigning, by the host service, a second role in the real estate transaction to the second party based on the second credential;
transmitting to the first instance by the host service a first configuration file based, at least in part, on the first role;
transmitting to the second instance by the host service a second configuration file based, at least in part, on the second role;
defining, based on the first configuration file, a first graphical user interface presented by the first instance, the first graphical user interface configured to redact and/or prevent display of information confidential to the second party; and
defining, based on the second configuration file, a second graphical user interface presented by the second instance, the second graphical user interface configured to redact and/or prevent display of information confidential to the first party.

12. The method of claim 11, wherein information confidential to the first party or the second party comprises:
financial information; or
identity information.

13. The method of claim 11, wherein the first graphical user interface is different from the second graphical user interface.

14. The method of claim 11, wherein one of the first party or the second party is a representative of a purchaser of real property.

15. The method of claim 11, further comprising:
encrypting the first configuration file prior to transmitting the first configuration file to the first instance.

16. The method of claim 15, further comprising:
encrypting the second configuration file prior to transmitting the second configuration file to the second instance; wherein
the first configuration file is encrypted in a different manner than the second configuration file.

17. A method of preventing unintended disclosure of confidential information exchanged between parties to a real estate transaction when closing the real estate transaction, each party operating respective one client device each executing a discrete instance of a client application, each discrete instance of the client application communicably coupled to a host service, the method comprising:
requesting, by an instance of the client application, a credential from a party to the real estate transaction;
assigning, by the host service, a transactional role to the party based on the credential;
transmitting by the host service to the instance a configuration file based on the transactional role;
receiving at the host service, from the instance, a request for a document related to the real estate transaction;
generating a redacted document by redacting at least a portion of the document based on the transactional role;
transmitting a redacted document to the instance; and
displaying at least a portion of the redacted document in a graphical user interface rendered by the instance, the graphical user interface defined by the configuration file.

18. The method of claim 17, wherein the document is stored by the host service.

19. The method of claim 17, wherein the document comprises:
computer readable data; or
an image representative of a paper document.

20. The method of claim 17, wherein the redacted document is encrypted prior to being transmitted to the instance.
